(19) United States
(12) Patent Application Publication
(10) Pub. No.: US 2013/0291106 A1
(43) Pub. Date: Oct. 31, 2013

(54) Enterprise level information alert system

(71) Applicants: Adam J. Simonoff, King George, VA (US); William E. Ward, III, Virginia Beach, VA (US); Brian D. Hobson, Virginia Beach, VA (US)

(72) Inventors: Adam J. Simonoff, King George, VA (US); William E. Ward, III, Virginia Beach, VA (US); Brian D. Hobson, Virginia Beach, VA (US)

(73) Assignee: United States Government, as represented by the Secretary of the Navy, Arlington, VA (US)

(21) Appl. No.: 13/373,748

(22) Filed: Nov. 23, 2011

(51) Int. Cl. G06F 21/00; G06F 11/00

(52) U.S. Cl. 726/23

(57) ABSTRACT

A Common Architecture System Assurance Information Assurance (IA) alert system that monitors IA events that may occur on a separate computer or computer system that is vulnerable to attack from internal misuse and penetration by outside sources. The system collects IA event messages and translates them into a common format for processing. It then analyzes the IA event, determines its seriousness, analyzes possible repairs for problems resulting from the IA event, and reports this information in real time to system monitors. These reports are in a readily-understood format this is free of computer jargon. The system reports are designed to be read and understood even by a person with limited education who is not trained in computer or IA technology.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to automated alert systems. In particular, the invention relates to systems intended to attract attention to particular events (e.g., intrusion from unauthorized access) using commonly used computer architecture.

Computer systems are vulnerable to attack, misuse and penetration by outside sources and persons who have internal access to physical systems. Billions of dollars are lost every year repairing systems hit by such attacks, particularly when vital systems are disrupted.

It is vital to determine that an intrusion has occurred and identify the type of intrusion. An intrusion detection system (IDS) is a device or software application that monitors network and/or system activities for malicious activities or policy violations and reports events which signal possible intrusion. Intrusion detection is focused on identifying possible incidents by logging information about them, and reporting attempts to engage in unauthorized activities that may compromise a network or system.

Once a possible intrusion event is detected, it is essential that effective protocols be in place and that monitoring personnel quickly and consistently carrying out intrusion detection protocols. Monitoring personnel who respond to the first sign of an intrusion are often critical to carrying out broader protocols that combat terrorism, cyber-warfare and other malicious activity. However, monitoring personnel often do not have specific technical backgrounds that allow them to quickly assess messages and data that reflect an imminent system intrusion.

Standards and protocols that define all aspects of intrusion detection response are collectively referred to as Information Assurance (IA).

Specific computer systems are certified as compliant with IA standards. IA standards encompass specific Department of Defense (DoD) standards related to hardware and software (e.g., DODI 8500.2 IA Controls: ECAT-2, ECND-2, ECRG-1, ECTB-1 and ECTP-1), as well as protocols for human response.

Monitoring event logs and other alerts is tedious and labor intensive, and generally requires the use of monitoring staff lacking specific technical knowledge. Event logs and messages must be discerned by monitoring personnel who must then convey critical system intrusion information to higher level staff. Enormous staffing resources are required for these monitoring functions, and it is important that they be performed with consistency.

Currently, IA standards are met through audit log monitoring and archiving on a weekly basis to identify anomalies that could be indicators of computer misuse or enemy penetration. DoD currently meets these IA logging and monitoring requirements using Commercial off-the-Shelf (COTS) interfaces which may be installed on various system components. Event log data may be stored in various formats, and may even utilize proprietary file formats. Generally, event log data is displayed in technical jargon unfamiliar to lay persons and monitoring personnel.

Many vital and protected government systems, including DoD warfare systems, are staffed by monitoring personnel who must interpret event log data without technical training. Skill and aptitude levels of monitoring personnel may be inconsistent. Monitoring personnel may have varying levels of responsibility for IA alerts.

It is vital that system administrators and chain of command personnel receive timely IA event alerts when a DoD system is being placed at risk. IA event alerts must reach commanding officers who need to know how the IA event affects mission readiness.

Current COTS Security Information and Security Event Management (SIEM) interfaces provide alert messages and reports that are familiar to trained information technology professionals, but difficult and tedious for non-technical monitoring staff.

For example, a typical COTS IA event alert might say: “Port 80 is flooded with malformed TCP/IP packets resulting in a Denial of Service.” Monitoring personnel may be trained to memorize an amalgamation of such alerts, but are limited by their non-technical backgrounds. It is difficult for the government to train and maintain sufficient levels of monitoring personnel with the training necessary to effectively interpret and convey IA alert information.

Current COTS interfaces cannot provide alert reports in a language or format that is readily understood by non-technical personnel and cannot abstract information to make it understandable. COTS SIEM interfaces are not designed to cue non-technical personnel to follow risk-mitigating protocols.

There is currently an unmet need for tools which optimize response time and accuracy of information conveyed by monitoring personnel.

### SUMMARY

Conventional alert systems yield disadvantages addressed by various exemplary embodiments of the present invention. In particular, various exemplary embodiments provide an Information Assurance (IA) alert system using Common Architecture System Assurance Information Assurance (CASA).

Various exemplary embodiments provide a CASA IA system containing an IA computer configured with intrusion detection software to generate an IA alert message. A CASA server configured with a MIC file stores intrusion event information which is converted to SQL format by a convertor for storage in a CASA database. A CASA processor generates an ILAO which is graphically displayed on a Monitoring Personnel interface.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 illustrates an exemplary embodiment of a CASA IA alert system;

FIG. 2A illustrates an exemplary embodiment of a user interface for a CASA IA alert system;

FIG. 2B illustrates an exemplary embodiment of a user interface for a CASA IA alert system;

FIG. 3 illustrates an exemplary embodiment of operational components of a CASA IA alert system; and

FIG. 4 is a flow chart diagram depicting an exemplary process for restoring a system following an alert.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a floating point gate array (FPGA) or other related component.

Terms of Art:

As used herein, the following terms can be defined as follows:

“Connector” refers to an interfacing component;
“Federal Information Processing Standards (FIPS)” refers to publicly announced standards developed by the U.S. Government for use in computer systems;
“event log” or “event log data” refers to data pertaining to an identifiable event which is permanently or temporarily stored;
“IA event message” refers to any message relating to an intrusion event;
“Information Assurance” or “IA” means the practice of managing risks related to the use, processing, storage, and transmission of information or data and the computer systems and processes used for those purposes;
“intrusion event” refers to any event which compromises a host system and which may cause the system to change from the state of health required for Continuity of Operations (COOP);
“intuitive language alert object” or “ILOA” refers to a data structure with properties and values that can be used to update a Monitoring Personnel Interface;
“main processor” refers to the computer circuitry and other hardware capable of executing complicated and sophisticated computer software;
“middleware” refers to software that provides an interface between application software that may be working on different computers or computer systems;
“monitoring personnel” means any person with responsibility for viewing an interface that displays data relevant to intrusion detection, and more specifically refers to personnel without technical training to interpret system data;
“quasi unique” means specific to a particular system or device;
“record object” refers to any data structure which contains data, such that a record object may or may not include or invoke functions;
“real time” means during a single user session or other time frame identified by a system protocol or administrator;
“redundant” refers to alternate or backup components to provide system continuity.

CASA IA Alert System:

For the purpose of promoting an understanding of the present invention, references are made in the text to exemplary embodiments of a Common Architecture System Assurance (CASA) Information Assurance (IA) alert system, only some of which are described herein. It should be understood that no limitations on the scope of the invention are intended by describing these exemplary embodiments.

One of ordinary skill in the art will readily appreciate that alternate but functionally equivalent materials, components, and configurations may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

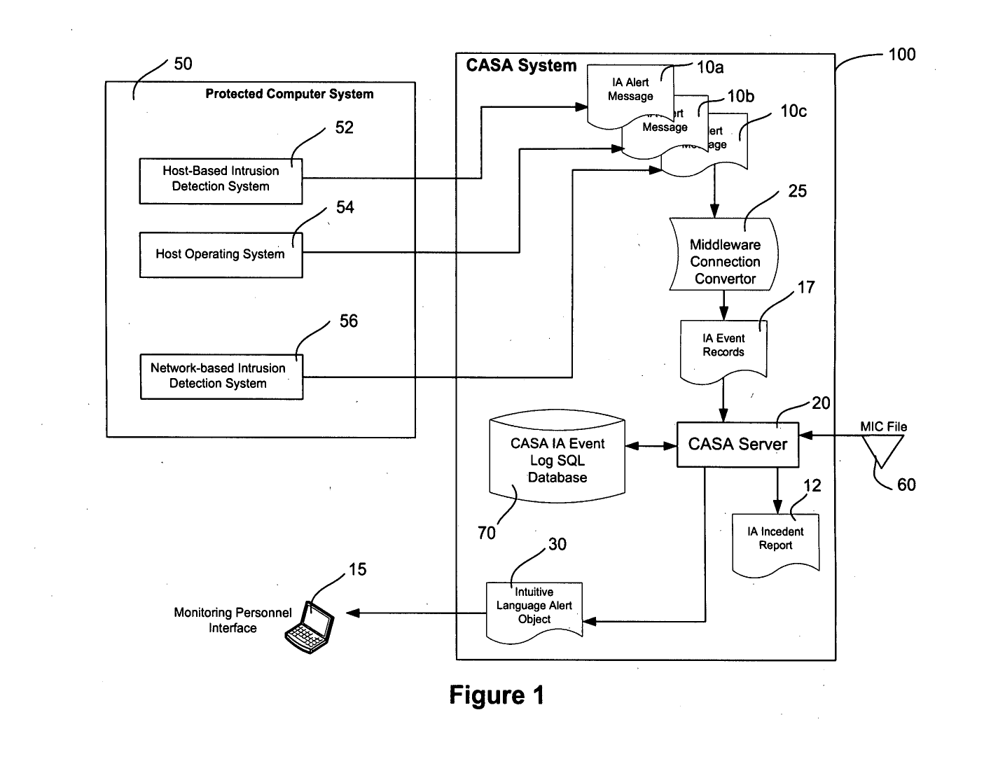

FIG. 1 illustrates an exemplary embodiment of CASA IA alert system 100. In the exemplary embodiment shown, Protected System 50 is a Department of Defense (DoD) computer system that is certified as compliant with IA standards. IA standards encompass specific DOD standards related to hardware and software (e.g., DODI 8500.2 IA Controls: ECAT-2, ECND-2, ECRG-1, ECTB-1 and ECTP-1).

In the embodiment shown, Protected System 50 includes Host-Based Intrusion Detection System 52, Host Operating System 54 and Network-Based Intrusion Detection System 56. Each Host System Component 52, 54, 56 is a computer hardware component configured with intrusion detection software to generate IA alert message 10a, 10b, 10c for various intrusion events.

In the embodiment shown, Host System Components 52, 54, 56 generate various IA alert messages, 10a, 10b and 10c determined by the COTS interface components. For example, IA alert message 10a is a message indicating file corruption on Host-Based Intrusion Detection System 52. IA alert message 10b indicates a failed root login or changed password and is generated by Host Operating System 54. IA alert message 10c, generated by Network-Based Intrusion Detection System 56, indicates information about a new device or port scan. Various software record objects contain alert message data.

As illustrated in FIG. 1, IA alert messages 10a, 10b and 10c are software records which contain properties and values which allow them to display messages using code abbreviations and technical language, providing detailed information to be interpreted by a technical professional. Generally, messages 10a, 10b and 10c can be accessed only by administrators and users having appropriate system level permissions and rights.

CASA IA alert system 100 is an alert system comprised of hardware configured with software for the particular system characteristics and threats relevant to Protected System 50. Each CASA IA alert system 100 has quasi-unique Mission Impact Configuration (MIC) settings, values and configurations. MIC configuration information is specific to Protected System 50.

In the embodiment shown, MIC settings are stored as MIC file 60, and MIC configurations may from time-to-time be updated by an administrator having appropriate permissions (e.g., consistent with Platform System Engineering Agent standards).

In the embodiment shown, CASA IA alert system 100 receives IA alert messages 10a, 10b and 10c through Middleware Connection Convertor 25. Middleware Connection Convertor 25 converts IA alert message properties and data derived from IA alert messages 10a, 10b and 10c to SQL format.

Middleware Connection Convertor 25 receives data record objects from Protected System Components 52, 54, 56 to create IA event record 17 which can be compared using IA Event Log SQL Database 70 as determined by MIC File 60. MIC File 60 determines how IA alert data is processed, and how values are extracted from IA alert record objects.

In the exemplary embodiment shown, up to ten alert categories may be defined by MIC File 60, and any textual description may be included next to a defined alert category. Other embodiments may include more or fewer alert categories which may be stored as record object files. Still other embodiments of CASA IA alert system 100 may allow IA alert record objects to be stored, searched, updated and modified.

MIC File 60 configurations also determine the type and number of events which trigger an alert and the threat level associated with an alert. For example, MIC File 60 may require a single event, such as a root login, or multiple events, such as a series of failed login attempts, to initiate an alert. In other exemplary embodiments, MIC File 60 configurations may determine more or fewer events are required to initiate an alert, or that specific event combinations will trigger alerts.

Settings stored in MIC File 60 determine how SQL data base is populated and updated, and in particular the data to which IA event record 17 is compared to determine whether the IA event record 17 contains data consistent with a potential threat. If IA event record 17 data is not consistent with a potential threat, the incident is merely recorded and stored as determined by the settings of MIC file 60.

Alternatively, if IA event record data 17 is flagged as consistent with a potential threat, an IA Incident report 12 is generated and processed by CASA server 20 which in turn generates intuitive language alert object (ILAO) 30. In the embodiment shown IA incident report 12 is a software record object which is transmitted to Monitoring Personnel Interface 15 and updates the display accordingly.

ILAO 30 is a software record or object which contains data and properties necessary to display intuitive language alert which may be viewed by monitoring personnel. In various embodiments, ILAO 30 may include other properties which may be updated and reflected on Monitoring Interface 15. For example, ILAO may include properties and values which reflect the state of computer system 50 or information contained in alert message 10. ILAO 30 may also contain data to display various prompts or cues relative to protocols for monitoring personnel to ensure that the system is restored to a status required for Continuity of Operations (COOP).

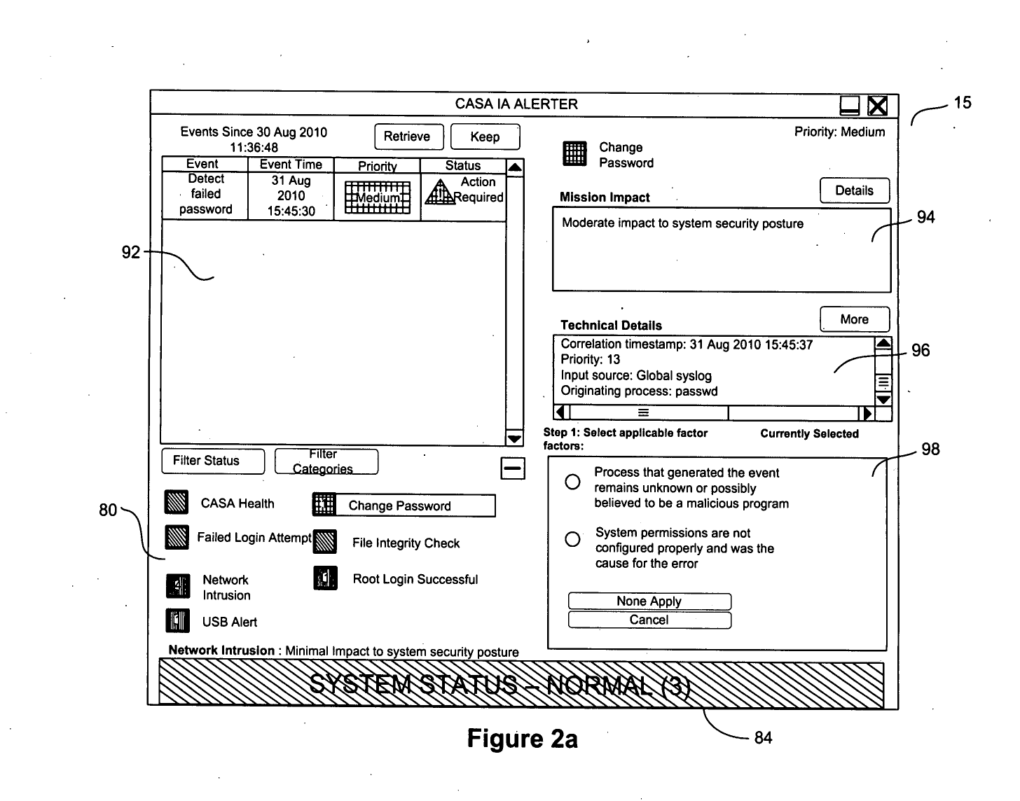

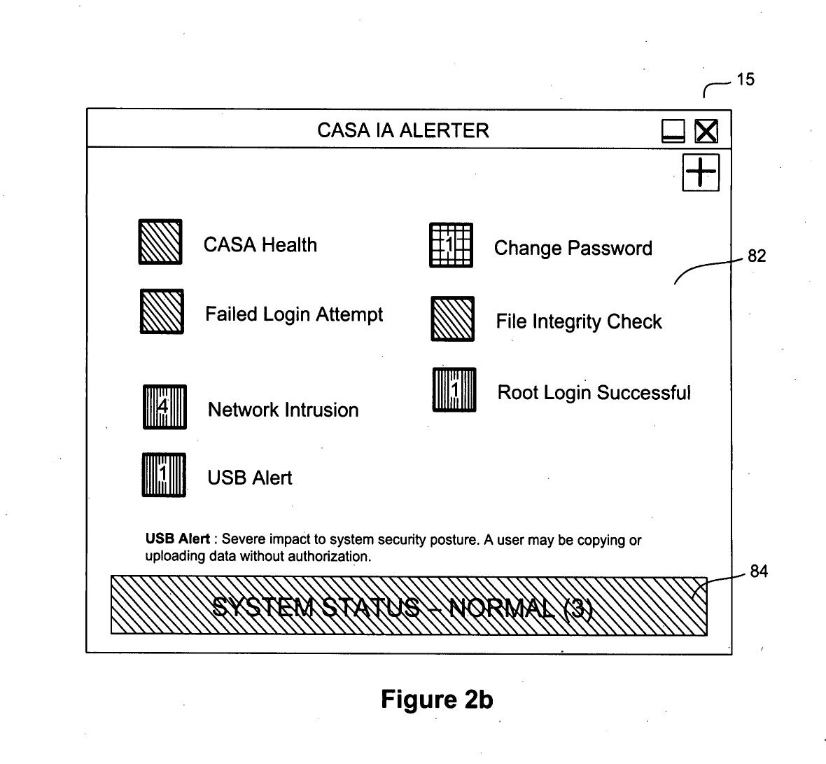

FIGS. 2A and 2B illustrate an exemplary embodiment of a display produced on Monitoring Personnel Interface 15. Monitoring Personnel Interface 15 is any graphical user interface (GUI) capable of displaying a viewable cuing interface determined by the properties of ILAO 30 (not shown). In various embodiments, ILAO receives and updates data and software objects which reflect one or more status changes for an IA-compliant system.

FIG. 2A illustrates an exemplary embodiment of a full display produced on Monitoring Personnel Interface 15. Event log display 92 is located at the top left of Monitoring Personnel Interface 15 and displays IA event information for events occurring over a duration in lay terms. In further exemplary embodiments, event log display 92 may include computer forensic information data relative to a status change of a computer system.

Event log display 92 may be sortable and filterable according to IA alert type. For example, IA Alerter Key display 80 provides a color-coded list of IA events. The number located within a color-coded key corresponds to the number of that type of incident recorded by event log display 92. In the exemplary embodiment shown in FIG. 2A, IA Alerter Key display 80 reflects 4 total network intrusion incidents, 1 root login successful incident and 1 USB alert. In further exemplary embodiments, IA events may be sorted or categorized into more or fewer groups.

IA Alerter Key 80 may also be displayed as a separate dashboard, as illustrated in FIG. 2B. Monitoring Personnel interface 15 also contains mission impact details display 94 which lists any impacts an IA event may have to Protected System 50. Technical details display 96, located near mission impact display 94, provides further details relating to an IA event displayed in event log 92 or described on mission impact display 94.

COOP procedures display 98 prompts monitoring personnel to complete procedures which restore a Protected System 50 to a usable state. As illustrated in FIG. 2A, COOP procedures display 98 is displaying the first step in restoring a system which experienced a failed password and generated an IA alert. Monitoring personnel must first decide the cause of the IA alert. Further steps in restoring the system will be determined based on the monitoring personnel's answer of further diagnostic questions. MIC file 60 contains all instructions and procedures for monitoring personnel to follow in response to an IA event. In the embodiment shown, Monitoring personnel interface 15 also contains system status bar 84, which provides a quick visual summary of the overall status of a Protected System 50. As illustrated in FIG. 2A, the overall system status is normal.

FIG. 2B is an exemplary embodiment of IA Alerter Key 80. IA alerts are displayed in color-coded categories. Colored boxes 82 indicate a threat level and contain a numerical representation of quantity of the specific type of IA alert. For example, as illustrated in FIG. 2B, the CASA Health box, Failed Login Attempt box and File Integrity Check box all appear in green, indicating a low threat level. System status bar 84 also appears green, confirming the system status of normal. MIC file 60 defines the event categories, threat level and system status.

In the exemplary embodiment illustrated in FIG. 2B, the Change Password box is yellow, indicating a mid-level threat to Protected System 50. IA Alerter Key 80 also indicates that one password change has occurred within the monitoring period. The Network Intrusion, USB Alert and Root Login Successful boxes each display as red, indicating a high-level threat to Protected System 50. A written description of any IA event may also be provided on IA Alerter Key 80. The color-coding and short-phrase display provided on Monitoring Personnel Interface 15 and IA Alerter Key 80 allow individuals without specialized training to understand the system and the risk associated with particular IA events.

In further exemplary embodiments, the information displayed on Monitoring Personnel Interface 15 may be configured for display or printing as a casualty report (CASREP), which organizes information about the cyber incident and how the cyber incident may affect mission readiness. In still further exemplary embodiments, information displayed by Monitoring Personnel Interface 15 may be selectively or cyclically configured for a collective incident report or audit report.

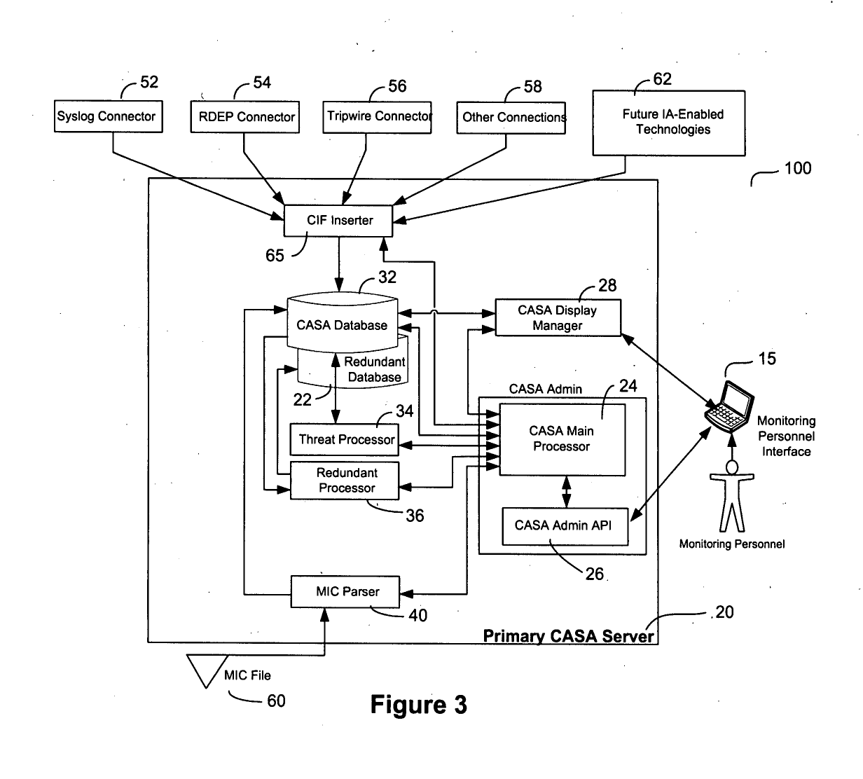

FIG. 3 illustrates an exemplary embodiment of operational components of CASA IA alert system 100. Connectors 52, 54 and 56 accept and collect industry standard security messages, such as IA alert messages, for translation into a common CASA format to be processed against its MIC rules. Security Device Event Exchange (SDEE) represents a standard proposed by ICSA Labs. In the exemplary embodiment shown, connectors include syslog connector 52, SDEE connector 54, and tripwire connector 56. For example, “syslog message per RFC 3164” is an IA event message that syslog connector 52 may collect, translate and forward to primary CASA server 70. Standards for connectors may optionally employ Remote Data Exchange Protocol (RDEP) and Simple Network Management Protocol (SNMP).

Other connections 58 and future IA-Enabled technologies 62 may also be used to collect IA alert events. In the exemplary embodiment illustrated in FIG. 3, connectors 52, 54, 56, 58, 62 reside outside of the system being monitored. In further exemplary embodiments, connectors 52, 54, 56, 58, 62 may reside on the system being monitored, such as Protected System 50. Consistent with DoD IA regulations, a connector will maintain all the IA events that it collects until they can be stored in CASA database 32 and redundant database 82.

IA events collected by connectors 52, 54, 56, 58, 62 are forwarded to CIF (CASA Input Format) Inserter 65. CIF inserter 65 stores events translated by connectors 52, 54, 56, 58, 62 in CASA database 32. CASA database 32 contains data relevant to Federal Information Processing Standards (FIPS) 127-2, including protocols and procedures which may be associated with IA alert message 10 by threat processor 34. In various embodiments, CASA database 32 may store other mission-critical information, such as computer security audit logs and draft messages.

In the exemplary embodiment shown in FIG. 3, threat processor 34 reviews IA alert messages stored in CASA database 32 and correlates IA alert messages with information in CASA database 32. Data which may be stored by database 32 and correlated by processor 34 may include information about the threat posed, protocols to be followed, persons and chain of command to be notified, information release data and other data relevant to IA alert message 10. Threat processor 34 then communicates its analysis to CASA main processor 24.

Also shown in FIG. 3 are Redundant Processor 36 and Redundant Database 22, which duplicate the data and processing capability of primary CASA server 20. If CASA server 20 cannot function for any reason, Redundant Processor 36 and Redundant Database 22 ensure continuity of monitoring and alerts. Redundant Processor 36 and Redundant Database 22 ensure that no IA alert message is lost.

In the exemplary embodiment illustrated in FIG. 3, MIC parser 40 receives and abstracts information pertaining to standards stored in MIC file 60 so data can be effectively compared, processed and stored in CASA database 32 and analyzed by threat processor 34. As illustrated in the exemplary embodiment shown in FIG. 3, CASA main processor 24 receives information from CASA database 32, including actions that initiated IA alerts and the results of IA event analysis from threat processor 34 and redundant processor 36, and transmits the information to CASA display manager 28 for display on Monitoring Personnel Interface 15.

CASA Admin Application Programming Interface 26 facilitates communication between monitoring personnel using Monitoring Personnel Interface 15 and CASA server 20. This enables monitoring personnel to interact with primary CASA server 20 in order to restore a protected system 50 to working order.

Upon receiving input from monitoring personnel using Monitoring Personnel Interface 15, CASA main processor 24 communicates with CASA database 32 and MIC parser 40 to determine the course of corrective action monitoring personnel should take. CASA main processor 24, through CASA display manager 28 continues to update Monitoring Personnel Interface 15 to prompt monitoring personnel through restoration steps.

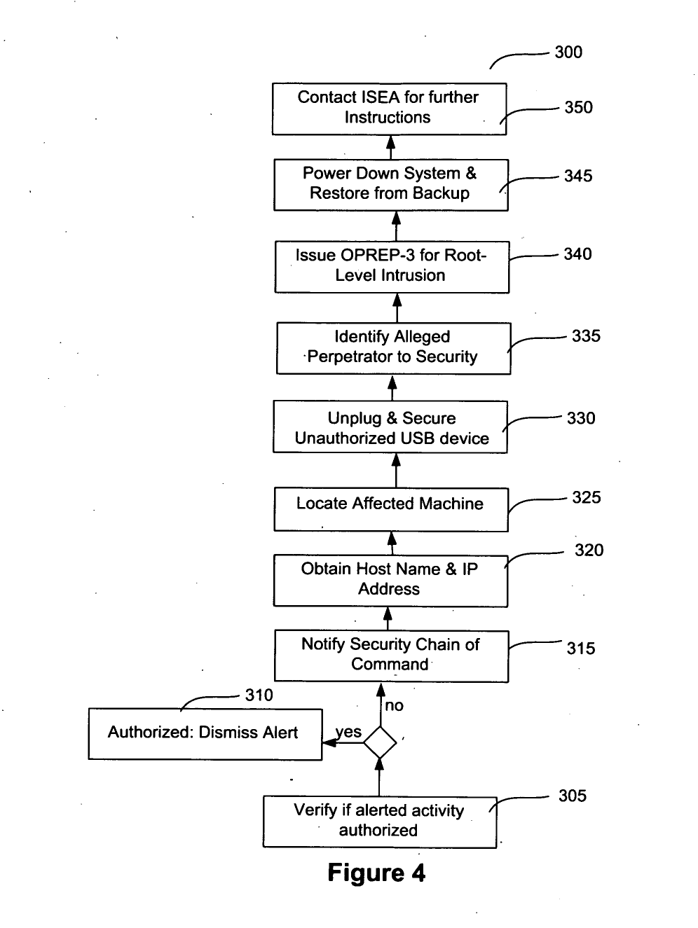

FIG. 4 is a flow chart illustrating exemplary steps for restoring a potentially compromised protected system when a root-level intrusion creates an alert. First, monitoring personnel must verify whether the alerted activity was authorized (Step 305). If the activity was authorized, the alert is dismissed (Step 310). If the activity was not authorized, monitoring personnel notify the appropriate security chain of command (Step 315).

In Step 320, monitoring personnel obtain the host name and IP address of the computer or other component where the alerted activity took place and locates the physical component (Step 325). Monitoring personnel should then unplug and secure any unauthorized universal serial bus (USB) or other device from the affected computer or other component (Step 330).

The alleged perpetrator to security is then identified in Step 335, and an OPREP-3 for Root-Level Intrusion is issued (Step 340). To bring the computer or other component back to operational, the system is powered down and restored from back up (Step 345), and In Service Engineering Agent (ISEA) is contacted for further instructions in Step 350.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. A Common Architecture System Assurance (CASA) system comprising:
An Information Assurance (IA) computer configured with intrusion detection software to generate an IA alert message in response to an intrusion event;
a CASA server configured to use a Mission Impact Configuration (MIC) data file, wherein said CASA server includes a CASA database that includes MIC alert information;
a Converter to convert said IA alert message to SQL format;
a CASA processor that converts said IA alert message to an intuitive language alert object (ILAO), said ILAO including technical details of said intrusion event and instructions for corrective action, said technical details including timestamp, priority, input and originating process; and
a graphical user interface (GUI) that displays said ILAO.

2. The system of claim 1, wherein said IA CASA database includes events IA event data for said identifying intrusion event when correlated with said IA messages.

3. The system of claim 1, which further includes an SQL server which is configured with software to associate event data with intrusion alert objects.

4. The system of claim 1, wherein said Converter is configured with software to receive alerts from a plurality of Protected System Component intrusion alert interfaces.

5. The system of claim 1, wherein said CASA processor is configured with software to create and update an ILAO record object to reflect a corresponding Protected System Component state.

6. The system of claim 1, wherein said ILAO record object invoices a function to display an alarm.

7. The system of claim 1, wherein said ILAO record object invokes a system response protocol function.

8. The system of claim 1, wherein said IA alert message is determined by a Commercial off-the-Shelf (COTS) interface displayed on a hardware device.

9. The system of claim 1, wherein said MIC file is configured to be updated by an administrator using a hardware device.

10. The system of claim 1, wherein said Converter is a middleware connection converter.

11. The system of claim 1, wherein said CASA processor disables said ILAO in response to said intrusion event being determined to be authorized.

12. The system of claim 1, which further includes a CASA IA event log SQL database configured to store said IA alert message.

13. The system of claim 12, wherein said CASA IA event log SQL database is searchable and sortable.

14. The system of claim 1, wherein said CASA server further includes a redundant CASA database and a redundant processor.

15. The system of claim 1, further including a connector selected from at least one of a syslog connector, a Security Device Event Exchange (SDEE) connector, and a tripwire connector.

16. The system of claim 15, further including a CASA Input Format (CIF) inserter configured with software to store events translated by said connector.

17. The system of claim 1, wherein said CASA server further includes a threat processor configured with software to correlate said IA alert with information in said CASA database.

18. The system of claim 1, wherein said CASA server further includes a CASA Admin API configured with software to facilitate communication between a user and said CASA system.

19. The system of claim 1, wherein said CASA server further includes a CASA display manager configured with software to dynamically update said GUI and receive user input.

20. The system of claim 1, wherein said CASA server further includes a MIC parser.

21. The system of claim 1, wherein said technical details include Mission Impact Engineering Data.

22. The system of claim 1, wherein said corrective instructions include operational procedures for restoration of the system to a baseline certified configuration.
